(19) United States
(12) Patent Application Publication
(10) Pub. No.: US 2005/0203846 A1
(43) Pub. Date: Sep. 15, 2005

(54) Self-service deposit equipment for banking

(75) Inventor: Milton Shizuo Noguchi, Sao Paulo (BR)

Correspondence Address: STEINBERG & RASKIN, P.C., 1140 AVENUE OF THE AMERICAS, 15th FLOOR, NEW YORK, NY, 10036-5803, US

(73) Assignee: Itautec Philco S/A - Grupo Itautec Philco

(21) Appl. No.: 10/603,384

(22) Filed: Jun. 25, 2003

(30) Foreign Application Priority Data
Jan. 21, 2003 (BR) PI0300066-4

(51) Int. Cl. G06F 17/60

(52) U.S. Cl. 705/42; 705/43

(57) ABSTRACT

The present invention relates to a self-service banking apparatus featuring among its modules a depositary module (1), including simultaneously, within itself, the following sub-modules: a bar code reader (6), a magnetic character reader (CMC7) (7); a scanner for image capture (8); a printer for deposited documents (9); a deposited documents accumulating device (10); a device for stacked document return (11); a recognizer of valid bills (12); an organized modular cassette (13) formed by various independent sub-modules (14), each one with a respective document stacking device; a transport channel (15); and a bill conveyor (16) to associate one organized cassette (13) to another organized cassette (17) which is also provided with a transport channel (18) and sub-modules (19), and inclusion of this cassette (17) in a bill dispenser device (20); the organized cassettes (13) and (17) which are self-locking, and consist of the following modules: a cassette cover (21); a cover lock module (22); a deposit compartment (23), a cassette retention module (24), and a retention pin (25).

### FIELD OF THE INVENTION

This invention relates generally to the technique used in self-service bank equipment directed for the automation and decentralization of bank services in general is well known and used more and more in the marketplace. With this equipment, the user (a client or bank employee) uses an appropriate interface to request and obtain certain services, directly interacting with the equipment, without the involvement of another person.

### BACKGROUND OF THE INVENTION

Among the various types of known self-service equipment, there are those that provide a unique and specific service to users, and others providing more than one service, depending on how many and which modules this equipment possesses. Thus, automatic teller machines (ATMs) are well known; some of them include deposit terminals, withdrawal terminals, consultation terminals, check dispensers, and others.

More specifically in relation to bank self-service equipment provided with integrated deposit terminals (also known as “depositaries”), there is equipment in which the deposits are made in envelopes, inside which the user may place checks and/or currency. In this equipment, the deposit terminal contains an inkjet printer or a bar code reader.

In the first instance (inkjet printer), when the deposit operation is begun and the checks and/or currency are placed inside the deposit envelope, through a man/machine interface the user provides all the information the bank requires to perform the deposit (account, agency number, deposited amount, etc.). This data will be printed on the envelope with the printer, then sent to a locked box provided inside the equipment, known as a cassette.

The inconvenience of this printer type is that, many times, its ink becomes depleted without the user's knowledge, resulting in many envelopes being deposited without due depository identification, requiring later tracking work to locate this information.

With the bank self-service equipment that processes deposits with bar code readers, each envelope is already provided with a respective and unique pre-determined code so that the information (account, agency numbers, amount to be deposited, etc.) provided by the user through the interaction interface is associated with that given envelope. In this instance, there is no inconvenience caused by printer ink depletion and the subsequent receipt of envelopes without identification; if for some reason, the bar code reader cannot read the bar code, the envelope is returned without performing the deposit.

The technique used in bank self-service equipment that doesn't receive envelope deposits but instead receives check deposits and currency bills one by one is also familiar; this equipment uses a magnetic character reader (CMC7 reader).

In the case of check deposits, with this type of deposit each check is deposited individually; the CMC7 reader captures the included data (account, bank, agency numbers, amount), and associates this check to the depositor's data—more specifically, to the information provided by the user through the man/machine interface (account number where the check will be deposited, agency number, amount to be deposited, etc.).

Additionally, some models of this type of deposit system use a scanner that scans the front and back of the check, reading and filing all the check data, as well as its amount, thereby operating as an additional safety system. Some models also use an inkjet printer which is able to “endorse” the check on the backside, printing the data that signifies that the check was deposited for that given account. And some models are also provided with a stamp which is able to “cross” the front of the check, granting more safety to the bank operation.

For currency deposits each bill is also deposited individually; the depositary scanner reads the bill, recognizes the amount, and associates this amount to the depositor's data provided through the man/machine interface (account number for the deposit, agency number, amount to be deposited, etc.).

As well as the bill scanning system for reading the amount, there are some depositary models that are provided with a bill authenticity monitoring system which uses a light beam that emits light waves able to recognize if the bill is false or not.

In light of what has been described above, we see that the market has several models of bank self-service equipment provided with a number of types of deposit terminals, or depositaries, which allow users to deposit directly in the machine. However, to complete this deposit, each depositary requires a certain procedure; with some depositaries, the deposit is made in envelopes and in others through the individual deposit of checks or bills.

The result of this is that many times the user is not completely satisfied with the self-service equipment available at a certain site. For example, if the user has many checks and/or a very high value in currency to deposit and the depository equipment provided accepts only individual deposits of checks and bills, the user will spend a lot of time to perform the deposit of all checks and/or bills. In this example, it would be better to perform the operation in depositary equipment that only accepts envelopes for the user to place all checks and/or bills.

A user with only one check and/or bill to deposit would be completely satisfied if he/she could deposit it in depositary equipment that accepts only individual checks and bills. However, when he/she finds depositary equipment that only accepts envelopes, he/she will spend more time to perform this deposit than if the operation was performed in the other type of equipment.

On the other hand, the various depositary models in the market also present different operation validation methods. In the case above of the depositary that only accepts envelopes, there are two methods to identify the envelope; a depositary provided with inkjet printer or with bar code reader. In the case of depositaries that accept only individual checks and bills, a magnetic character reader (CMC7) is provided.

Such methods present certain reliability and safety characteristics, which, although acceptable, could be better if the above mentioned methods could be used simultaneously, that is, together.

And so, as described above, it is verified that in spite of the wide choice of self-service bank equipment techniques that allow automatic deposit, all present certain use and reliability limits and don't comply completely and satisfactorily with all the market demands.

### SUMMARY AND OBJECTS OF THE INVENTION

Thus, in trying to fulfill this gap in the market, the Applicant has developed these improvements in self-service deposit equipment for banking, making it possible to place in the same deposit terminal or depositary all deposit possibilities; that is, check or currency deposits inside envelopes, individual check deposits (one by one) and currency bill deposits (one by one). Additionally, these improvements make it possible to place together in a single and same depositary all forms of operation validation—inkjet printer, bar code reader and magnetic character reader (CMC7).

For this, the Applicant has developed a series of sub-modules for the depositary module provided in the equipment, allowing the simultaneous addition of all those functions which before now could only be obtained independently and at different depositaries.

As well, these improvements provide the depositary module with a series of additional sub-modules which perform the functions that have not yet been provided in known and marketed depositaries.

One of these innovations provides a deposit accumulator for returning stacks. This accumulator is responsible for the temporary accumulation of checks and/or bills introduced into the machine during the deposit operation; if the user cancels the operation for any reason, the machine immediately returns the check and/or bill stack without completing the operation.

Another innovation provides an “organized cassette” able to direct the different received documents to specific compartments (one for receiving envelopes, one for receiving checks, and several for receiving bills, separating them according to their value). Additionally, when receiving checks and/or currency bills, this organizer cassette is able to organize them all in the same position, in vertical and/or horizontal stacks, allowing for the best use of space since it groups a large number of documents in a very small space. This facilitates the subsequent forwarding of received documents after the authorized opening of the sealed cassette.

As well, this new organized cassette allows for the introduction of another great innovation: the provision of a bill dispenser device associated to the cassette. With the interconnection of these two components, the same currency bills deposited by the users at the improved depositary are duly directed, according to their value, to the respective compartments of the organized cassette and may be used to provide currency to other users through withdrawal operations. In this way, self-service equipment provided with the improved depositary becomes completely integrated with its deposit and withdrawal terminals, allowing for the use of the same bills for both, thus reducing the number of operations to feed the withdrawal terminal by bank employees; in other words, the withdrawal terminal is continuously fed with the bills from the deposit terminal.

Additionally, this improved organized cassette is self-locking. After being placed in the depositary of the bank self-service equipment, and its cover is opened, this act automatically drives an internal retaining system that prohibits the removal of the cassette from the depositary, thus stopping the violation of its deposited contents. To remove the cassette from the depositary, it is necessary to close its cover. This act automatically drives an internal locking system which locks the cassette and releases the cassette retention system. Only then can the cassette be removed from the depositary. Once removed, the cassette remains locked until opened by an authorized employee with a special key. The cassette cover remains unlocked until it is subsequently placed in the equipment depositary and the cycle begins again.

This improved depositary also allows bill payment—not only bills of clients of the bank associated to it when payment is done through automatic debit, but also the bills of third parties. In this case the depositary scans the document to be paid, receives and scans for validation and value the check or currency to pay the bill, and, through the man/machine interface, performs the association of that check or currency to the bill payment.

Finally, these improvements make the depositary in question totally modular and scalable, allowing for the addition/removal of several modules and sub-modules according to the market needs and demands. Thanks to these modularity and scalability characteristics, the depositary in question may offer various versions—from the simple (basic model) to the most complex (complete model), each one completely fulfilling user needs.

With all these provided innovations, self-service equipment provided with the depositary in question practically constitutes a totally automatic mini bank able to perform multiple operations and functions, including: deposit of checks and/or currency in envelopes, individual check deposits, currency deposits, currency recycling and supply, bill payments, etc. Before this, these operations and functions were automatically performed in different depositaries and never in one depositary.

### BRIEF DESCRIPTION OF THE DRAWINGS

For purposes of illustration, attached are the drawings of this invention, which will allow better visualization:

FIG. 1 is a block diagram of the improved self-service equipment in accordance with the invention;

FIG. 2 is also a block diagram of an improved self-service equipment in accordance with a second embodiment of the present invention;

FIG. 3 is a block diagram of the improved self-service equipment in accordance with a third embodiment of the present invention;

FIG. 4 is a block diagram of the improved self-service equipment in accordance with a fourth embodiment of the present invention;

FIG. 5 illustrates the components of the organized cassette, presented as self locking.

### DETAILED DESCRIPTION OF THE INVENTION

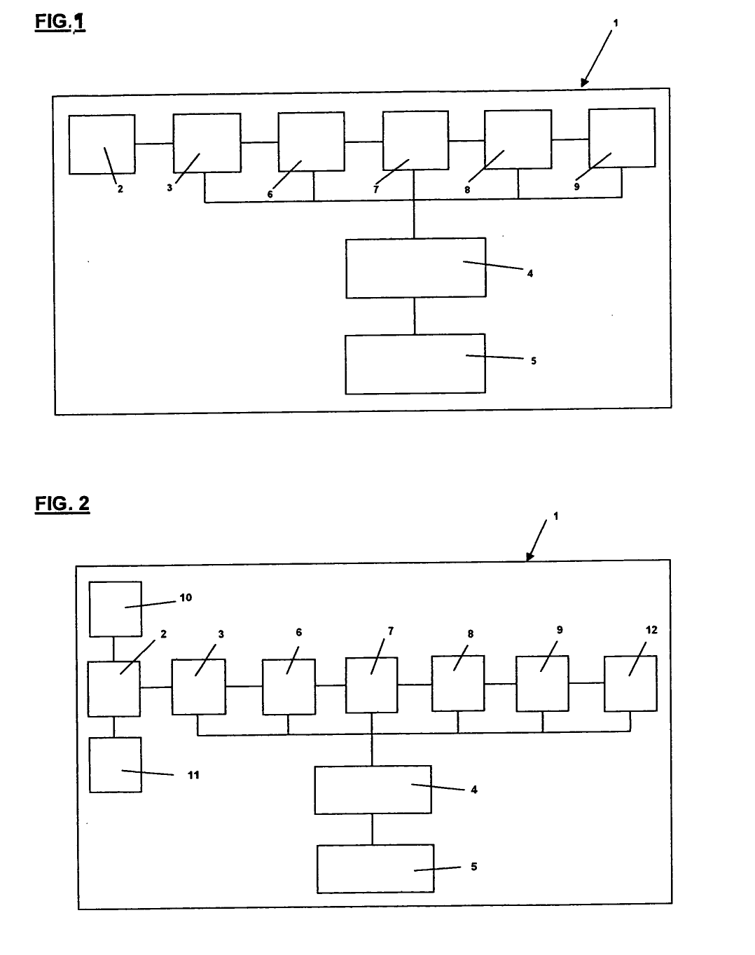

The object of this Invention patent is relative to self-service deposit equipment for a bank equipment of the type that presents, among its modules, a depositary module (1), which, as illustrated in the FIG. 1 block diagram, consists of the following sub-modules: a document receiving door (2) that is able to receive documents in total safety without allowing vandalism, a document duplicity detector (3) able to detect the eventual introduction of double pages, a document director (4) which directs the introduced documents to a deposit cassette, and a deposit cassette (5).

According to these improvements, the mentioned depositary module (1) includes simultaneously, within itself, the following sub-modules: a bar code reader (6), able to read the bar code included on any document (envelopes, bills, etc.), a magnetic character reader (CMC7) (7), able to read the characters included on any document (more specifically, checks); a scanner for capturing images (front and back) (8) able to digitalize and file the image of any document (checks, currency bills, etc.); and a printer for deposited documents (9), for printing the identification or other data on any document.

With the simultaneous provision of all these sub-modules (6) to (9) in the depositary module (1), the depository can perform by itself all deposit possibilities, be it currency or check deposit in envelopes, individual check deposits (one by one) and currency bill deposits (one by one), as well as all validation operations, by printing identification data on any document, reading the bar codes included on any document, or even reading the magnetic characters included on any document.

The depositary module (1) described above and illustrated in attached FIG. 1 describes the first version of this invention, in which the resulting self-service equipment is the simple version (basic model).

Another version for this invention, presented in the FIG. 2 block diagram, provides some additional sub-modules to the depositary module (1) of the self-service equipment in question. Thus, as well as the usual sub-modules (2) to (5), and the sub-modules (6) to (9) provided in the former version, this depositary module (1) houses, simultaneously, the following sub-modules: a deposited document accumulator device (10), which is able to receive documents and arrange them in stacks; a device to return the stacked documents (11), which is able to return the documents accumulated in stacks; and a recognizer for valid bills (12), which able to recognize and validate deposited bills.

With the provision of sub-modules (10) and (11), the depositary module (1) allows for the temporary accumulation of documents (checks and/or bills) introduced into the machine during deposit operations; in the event the user cancels the operation for any reason, the depositary module (1) allows for the immediate return of these documents, as a stack, without completing the operation. Additionally, with the provision of sub-module (12), if an introduced bill is detected as having non-valid paper/ink/printing, the operation is cancelled.

An integral part of the depositary module (1), and indispensable for the integration of sub-modules (2) to (11) described above, is an intelligent conveyor mechanism. This provided part is responsible for moving the deposited document among the mentioned sub-modules and aligning these received documents. The conveying mechanism is automatically adjusted according to the thickness of the deposited documents. This permits the safe manipulation of any document, from single page documents, to envelopes containing fifty bills. This mechanism is able to facilitate accuracy of document transportation and alignment, with excellent handling capacity dealing with a wide thickness range.

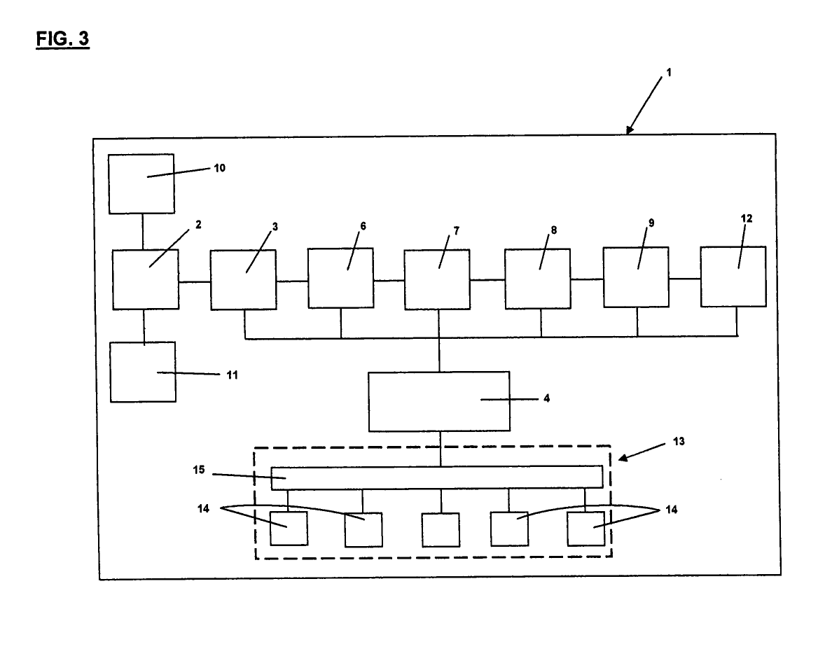

Yet another version for this invention, shown in the FIG. 3 block diagram, provides the depositary module (1) in question with some additional sub-modules. As well as the usual sub-modules (2) to (4), and sub-modules (6) to (12) provided in the former version, the depositary module (1) simultaneously includes the following sub-modules: a modular organizer cassette (13) formed by several independent sub-modules (14) to store deposited documents, each one with a respective document stacking device; and a transporting channel (15) to convey and direct the documents.

With the provision of this organized cassette (13), when receiving documents (envelopes, checks and/or bills, etc.), the depositary module (1) is able to direct the different received documents through the transporting channel (15), to the various sub-modules (or compartments) (14) of the organized cassette (13) (for example, one for receiving envelopes, one for receiving checks and several for receiving bills, separating them according to their value). Additionally, through the stacking devices integrating each sub-module (14), it is possible to arrange the documents (more specifically the checks and bills) in the same position, stacking them vertically and/or horizontally, allowing better use of space, since it allows for grouping a large number of sheets in a very small space.

With this, the subsequent forwarding of received documents is facilitated when the sealed cassette is open.

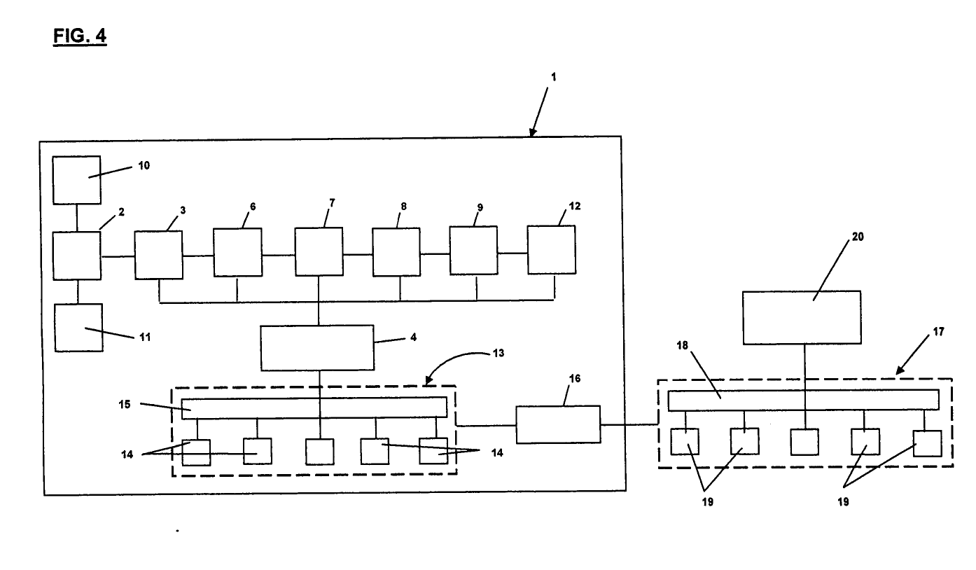

And in another version for this invention, shown in the FIG. 4 block diagram, as well as being provided with the usual sub-modules (2) to (4), and sub-modules (6) to (15) offered in the former version, the depositary module (1) in question simultaneously includes another additional sub-module, that is, the bill conveyor (16), which allows for the organized cassette (13) to be associated to another organized cassette (17) also provided with a conveyor channel (18) and sub-modules (19). This cassette (17) is part of a bill dispenser device (20).

Since the organized cassettes (13) and (17) are interconnected, the same currency bills deposited by users through deposit operations in the improved depositary (1), and duly directed to the respective compartments (14) of the organized cassette (13) according to their value, are used to supply currency to withdrawing users through the bill conveyor device (16) thus innovated, which directs the mentioned, ordered bills to the sub-modules (19) of the cassette (17), and from these through the channel (18) to the bill dispenser device (20).

Thus, in this fourth version, the self-service equipment provided with the improved depositary is offered with deposit and withdrawal terminals completely integrated, allowing for the use of bills for both.

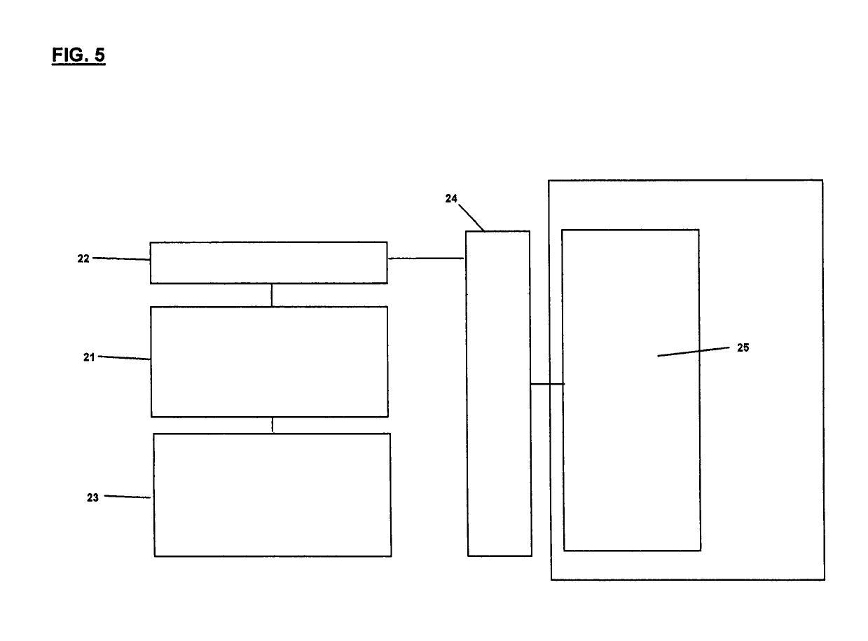

Also according to these improvements, the organized cassette (13) thus innovated is self-sealing. As shown in the FIG. 5 block diagram, this cassette (13) consists of the following modules: a cassette cover (21) which closes and seals the full cassette for transport; a cover lock module (22), which is configured by a mechanical system able to lock the cassette cover; a deposit compartment (23) (consisting of independent sub-modules (14) already mentioned) for storing the received deposits; a cassette retention module (24) operating together with the cover lock module (22) and configured by a mechanical system able to keep the cassette locked in to the depositary module; and a retention pin (25), fixed to the depositary module and necessary for the cassette retention system.

After placing the organized cassette (13) in the bank self-service deposit equipment, the cover is opened (21). The act of opening the cover (21) automatically activates the cassette retention module (24) so that the cassette cannot be removed from the depositary, thus avoiding the violation of its deposited contents. To remove the cassette (13) from the depositary, the cover (21) must be closed. This cover closing act automatically activates the cover lock module (22), which locks the cassette cover, releasing the cassette retention module (24) and allowing for its removal from the equipment.

Once removed from the depositary, the cassette (13) remains sealed until it is opened by an authorized employee with the appropriate wrench. The cassette cover (13) remains unlocked and after being emptied, the cassette is placed back in the depositary and the cycle is reinitiated.

Obviously, the organized cassette (17) provided in the forth version of this invention is also self locking, consisting of the same modules mentioned above.

With all these provided innovations, a bank self-service equipment provided with the improved depositary is able to perform several operations and functions; among them, check and/or currency deposits in envelopes, individual check deposits, currency deposits, currency recycling and supply, bill payments, etc., which before now where automatically performed only in different depositaries, and never in the same one.

1. Self-service banking apparatus, comprising:
a depositary module (1) consisting of the following sub-modules: a document receiving door (2), a document duplicity detector (3), a document guider (4) and a deposit cassette (5) provided with self locking cover, wherein the depositary module (1) includes within itself simultaneously the following sub-modules: a bar code reader (6) for reading the bar codes on any documents; a magnetic character reader (CMC7) (7) for reading the characters included on any document; a scanner for image capturing (8) which digitalizes and files the image of any document (front and back); and a printer (9) for printing identification or other data on any deposited documents.

2. The self-service banking apparatus according to claim 1, and in an optional version, in which the depositary module (1) is also provided with sub-modules (2) to (5) and sub-modules (6) to (9) offered in the former version, wherein the depositary module (1) integrating within itself simultaneously the following sub-modules: a deposited document accumulator device (10) for receiving and arranging the documents in stacks; a device for returning stacked documents (11) which returns the accumulated stacked documents; and a valid bill recognizer (12), to recognize and validate the deposited bills.

3. The self-service banking apparatus according to claim 2, and in an optional version, in which the depositary module (1) is also provided with sub-modules (2) to (5) and sub-modules (6) to (12) offered in the former version, wherein the depositary module (1) simultaneously integrating within itself the following sub-modules: modular organized cassette (13) formed by several independent sub-modules (14) to store the deposited documents, each one with a respective document stacking device; and a transport channel (15) to transport and orient the mentioned documents.

4. The self-service banking apparatus according to claim 3, and in an optional version, in which the depositary module (1) is also provided with sub-modules (2) to (5) and sub-modules (6) to (15) offered in the former version, wherein the depositary module (1) integrating within itself simultaneously a bill conveyor (16) to connect the mentioned an organized cassette (13) to another organized cassette (17) also provided with a transport channel (18) and sub-modules (19), making such cassette (17) integral to a bill dispenser device (20).

5. The self-service banking apparatus according to claim 2, wherein the depositary module (1) being provided with an intelligent conveying mechanism responsible for moving the deposited document between all sub-modules (2) to (11), and for the alignment of received documents; this intelligent conveying mechanism is automatically adjustable according to the thickness of the deposited document, from a single bill up to envelopes with fifty bills.

6. The self-service banking apparatus according to claim 4, wherein the self-sealing properties of the organized cassettes (13) and (17) consisting of the following modules: a cassette cover (21) to close and seal the full cassette for transport; a cover lock module (22) configured by a mechanical system to lock the cassette cover; a deposit compartment (23) to store the received deposits; a cassette retaining module (24) which operates together with the cover lock module (22) which is configured by a mechanical system to keep the cassette locked in the depositary module; and a retention pin (25), fixed to the depositary module.

7. The self-service banking apparatus according to claim 1, wherein the depositary module (1) presenting as modular and scaled, allowing for the addition/removal of various modules and sub-modules according to market needs and/or request.

8. The self-service banking apparatus according to claim 1, wherein the depositary module (1) permits the automatic accomplishment of multiple operations and functions simultaneously including: check and/or currency deposits in envelopes, individual check deposits, currency deposit, currency recycling and supply, bill payments, etc., in single equipment.
